(19) United States
(12) Patent Application Publication
(10) Pub. No.: US 2004/0173112 A1
(43) Pub. Date: Sep. 9, 2004

(54) Rewetting installation for a material web and a method for improving the anti-frictional properties of a material web

(76) Inventor: Anton Weis, Lorsch (DE)

Correspondence Address: Douglas R Hanscom, Jones Tullar & Cooper, Eads Station, PO Box 2266, Arlington, VA, 22202, US

(21) Appl. No.: 10/485,112

(22) PCT Filed: Jul. 19, 2002
(86) PCT No.: PCT/DE02/02659

(30) Foreign Application Priority Data
Aug. 9, 2001 (DE) 101-39-219.2

(51) Int. Cl. B41F 13/54

(52) U.S. Cl. 101/228

(57) ABSTRACT

The invention relates to a rewetting installation for a printed and dried material web (01). Said installation (03, 04) comprises a respective wetting device for applying a silicon emulsion to a first and/or second side of the material web and at least one secondary wetting device (08, 09), located at a distance from the wetting devices for the renewed application of silicon emulsion to at least one side of the material web.

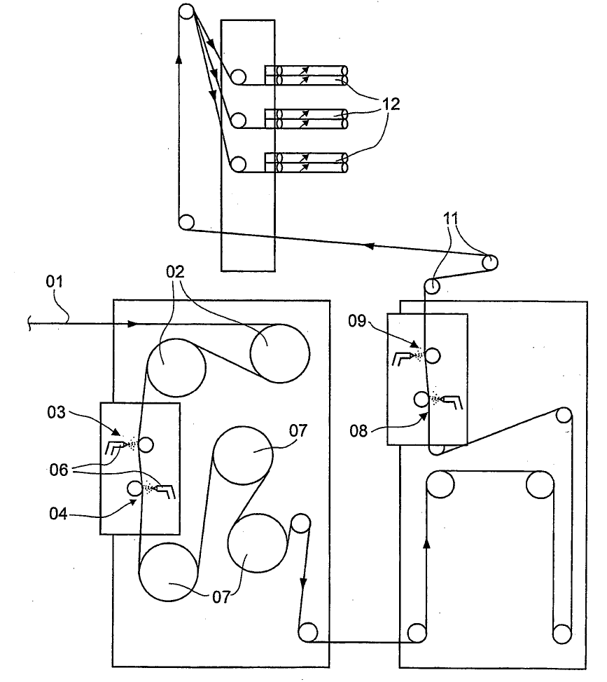

The invention relates to a re-moistening installation for a web of material and a method for improving the running properties of a web of material in accordance with the preamble of claims 1 or 8.

In high-speed printing presses an imprinted paper web is often dried by the effects of heat in order to set the printing ink and to prevent the smearing of insufficiently dried ink on rollers over which the imprinted web is guided. However, this treatment does not only result in the desired drying of the paper surface, but more than that to a loss of moisture in the composite material of the paper, which can lead to deformation or formation of waves in the paper, which considerably detracts from the appearance and useful value of the finished printed product. For the prevention of such deformations it is known to conduct a heat-dried paper web through a re-moistening installation, in which the lost moisture is supplied again. This is done with the aid of moistening devices in the form of arrays of spray nozzles, which distribute a fine fog of a water-silicon emulsion on the front and back of the web.

The addition of silicon oil to the water has a number of advantages, among which are an increase in the surface quality, and therefore a reduced friction on guide rollers and formers, reduced smearing and smear deposition on formers and the folding apparatus, etc. The extent to which these advantages can be gained of course depends on the concentration of the silicon oil in the emulsion. The usual practice therefore is to adapt this concentration to such a degree that the mentioned advantages can be gained to the highest possible degree. However, smearing and the deposition of smears cannot completely be prevented, soiling of the guide rollers of a folding apparatus on which the moistened web is processed following re-moistening, can be observed even with a carefully optimized additive concentration in the emulsion.

DE 44 05 332 A1 describes a re-moistening system in the cooling roller stand of a web-fed offset printing press, wherein a plurality of moistening devices is assigned to each side of a web.

DE 199 20 091 A1 discloses a re-moistening liquid with silicon.

The object of the invention is based on producing a re-moistening installation for an imprinted web of material, and a method for improving the running properties of a web of material.

In accordance with the invention, this object is attained by means of the characteristics of claims 1 or 8.

The re-moistening installation has the surprising advantage that it permits a reduction of soiling clearly to below the amount which can be achieved by the careful optimization of the silicon content in a conventional re-moistening installation. A possible explanation of this effect is that in case of re-moistening the emulsion applied in two steps is distributed in a different way on the web of material than with re-moistening in one step. In connection with re-moistening in one step is is assumed that the applied emulsion penetrates the material in a continuous stream, so that a high degree of surface moisture can only be achieved after the material has absorbed a considerable amount of moisture in its interior, which can be greater than would correspond to the moisture content of the material prior to printing. In a way similar to excessive drying, such excessive moistening of the material can lead to problems in further processing.

But with two-stage re-moistening, first the water from the first re-moistening step is absorbed by the material, while the silicon oil remains in the area of the surface of the material and there partially closes the pores. A moisture dosage applied in the second step can therefore not penetrate the material to the same extent, it therefore remains concentrated on the surface to a great extent and there improves the surface properties of the material without moistening it in excess in the course of this.

The sole drawing FIGURE shows a re-moistening installation in greatly schematized section.

The web of material 01, for example a paper web 01, which was dried by heating in a drying installation (not represented), is initially guided at the entry to the re-moistening installation around two rollers 02, for example cooling rollers 02, which touch the front and back of the paper web 01. The paper web 01 precooled in this way arrives at two moistening devices 03, 04, which are arranged at short distances one behind the other at the paper web 01 and each of which contains a plurality of spray nozzles 06, which are arranged in a row transversely in respect to the running direction of the paper web 01, and spray a finely dispersed silicon oil-water emulsion on the two sides of the paper web 01.

The paper web 01 once moistened on both sides in this way then arrives at a second cooling roller arrangement, wherein each side of the paper web comes into contact with at least one roller 07, for example a cooling roller 07. The contact with the cooling rollers 07 aids the even distribution of the emulsion on the paper web 01 and its penetration. The purpose of these first re-moistening devices 03, 04 is essentially the compensation of the moisture loss which the paper had suffered during the previous passage through the drying installation.

As soon as the water applied by the moistening devices 03, 04 has begun to be distributed in the paper which, with a customary running speed of the paper web 01, is the case after a path length of at least 5 m, the paper web 01 arrives at two re-moistening devices 08, 09, which are structurally identical with the above mentioned moistening devices 03, 04, but which can apply a silicon oil emulsion of a different dosage and/or concentration. This second dosage impinges on a paper surface which had already been enriched with the silicon oil of the first dosage. It therefore penetrates the paper less rapidly and at the same time keeps the paper surface smoother and more slippery than would be possible with single moistening. Because of this, the amount of dirt which is deposited on downstream-located rerouting rollers 11, turning bars 12 and parts of a folding apparatus, not represented, etc. is reduced. The possibility of malfunctions is reduced because of the improved cleanliness, and the maintenance outlay is also reduced.

List of Reference Symbols

01 Web of material, paper web

02 Roller, cooling roller

03 Moistening device

04 Moistening device

05 -

06 Spray nozzle

07 Roller, cooling roller

08 Re-moistening device

09 Re-moistening device

10

11 Rerouting roller

12 Turning bar

1. A re-moistening installation for an imprinted web (01) of material, having a moistening device (03, 04) each for the application of a silicon emulsion to a first and/or second side of the web (01) of material, characterized in that at least one re-moistening device (08, 09) for the renewed application of silicon emulsion to the first side of the web (01) of material is arranged spaced apart from the moistening devices (03, 04), and that the length of the web (01) of material between the moistening device (03, 04) and the re-moistening device (08, 09) acting on the same side of the web (01) of material is at least 5 m.

2. The re-moistening installation in accordance with claim 1, characterized in that at least one roller (07) which touches the first side is arranged between the moistening device (03, 04) for the application of silicon emulsion to the first side and the re-moistening device (08, 09).

3. The re-moistening installation in accordance with claim 1 or 2, characterized in that a further re-moistening device (08, 09) for the renewed application of silicon emulsion is also provided for the second side of the web (01) of material.

4. The re-moistening installation in accordance with claim 3, characterized in that a roller (07) which touches the second side is arranged between the moistening device (03, 04) for the application of silicon emulsion to the second side and the second re-moistening device (08, 09).

5. The re-moistening installation in accordance with claim 2 or 4, characterized in that the rollers (07) are cooling rollers (07).

6. The re-moistening installation in accordance with one of the preceding claims, characterized in that the length of the web (01) of material between a moistening device (03, 04) and a re-moistening device (08, 09) acting on the same side of the web (01) of material is at least 5 m.

7. The re-moistening installation in accordance with one of the preceding claims, characterized in that the re-moistening devices (08, 09) are structurally identical with the moistening devices (03, 04).

8. A method for improving the running properties of a web (01) of material, wherein a silicon emulsion is applied to both sides of the web (01) of material, characterized in that the application of the silicon emulsion to at least one side of the web (01) of material takes place in two spaced-apart steps, wherein the dosage and/or concentration of the silicon emulsion is different in the two steps.

9. The method in accordance with claim 8, characterized in that silicon emulsion is applied to both sides of the web (01) of material in two spaced-apart steps.

10. The method in accordance with claim 8 or 9, characterized in that between the first and second steps of the application of silicon emulsion on one side of the web (01) of material this side is touched by a roller.
